(19) United States
(12) Patent Application Publication
(10) Pub. No.: US 2020/0355651 A1
(43) Pub. Date: Nov. 12, 2020

(54) DETECTION METHOD FOR CONGENERS OF SHORT-CHAIN CHLORINATED PARAFFINS

(71) Applicant: Shimadzu Corporation, Kyoto-shi (JP)

(72) Inventors: Yun ZOU, Beijing (CN); Naoki HAMADA, Beijing (CN); Liang DONG, Beijing (CN)

(73) Assignee: Shimadzu Corporation, Kyoto-shi (JP)

(21) Appl. No.: 16/851,555

(22) Filed: Apr. 17, 2020

(30) Foreign Application Priority Data
May 9, 2019 (JP) 2019-089135

(51) Int. Cl. B01J 20/281; G01N 30/72; G01N 30/54

(52) U.S. Cl. CPC G01N 30/482; G01N 30/54; G01N 30/7206

(57) ABSTRACT

The present disclosure relates to a detection method for congeners of short-chain chlorinated paraffins as well as a device for realizing the detection method. The detection method includes the following steps: adding an internal standard substance to a test sample; subjecting the test sample to a separation process using a comprehensive two-dimensional gas chromatograph formed by connecting a non-polar or weak-polar column and a medium-polar column in series via a modulator; and detecting the sample by a mass analyzer employing a negative chemical ion source after the separation process. The method according to the present disclosure enables accurate qualitative analysis as well as accurate quantitative measurement for short-chain chlorinated paraffins. The detection is extremely accurate yet can be easily carried out with simple operations.

### TECHNICAL FIELD

The present invention relates to a detection method for congeners of short-chain chlorinated paraffins, and more specifically, to a method for detecting congeners of short-chain chlorinated paraffins using a comprehensive two-dimensional gas chromatograph coupled with a low-resolution mass analyzer.

### BACKGROUND ART

Chlorinated paraffins (which may be abbreviated as CPs) are a known type of synthetic n-alkane chlorinated derivatives widely used for various industrial products, such as metal-cutting liquids, sealing agents, adhesives or rubber. According to the lengths of their respective carbon chains, chlorinated paraffins can be classified into short-chain chlorinated paraffins (abbreviated as SCCPs; carbon numbers, 10-13), medium-chain chlorinated paraffins (abbreviated as MCCPs; carbon numbers, 14-17), and long-chain chlorinated paraffins (abbreviated as LCCPs; carbon numbers, 18-30).

SCCPs are comparatively stable in the natural environment and exhibit various characteristics, such as the hard-to-decompose nature (low solubility), high persistence, toxicity, bioaccumulation potential, and long-distance mobility. Accordingly, SCCPs are placed under strict control in their production, use and discharge. In 2017, SCCPs were officially listed in the annexes to the “Stockholm Convention on Persistent Organic Pollutants” in the Eighth Session of the Conference of the Parties of the Stockholm Convention (COPE).

As a technique for separating SCCPs, one-dimensional gas chromatography has been commonly known.

### CITATION LIST

### Non Patent Literature

Non Patent Literature 1: G. T. Tomy, “Analysis of Chlorinated Paraffins in Environmental Matrices: The Ultimate Challenge for the Analytical Chemist, The Handbook of Environmental Chemistry, vol 10, 2009, pp. 83-106

### SUMMARY OF INVENTION

### Technical Problem

Another example is a detection method in which low-resolution mass spectrometry in a selective ion monitoring (SIM) mode is combined with gas chromatography. Low-resolution mass spectrometry has the advantage that this method is easy to operate and lowers the operation cost. However, since SCCPs are a complex mixture including various congeners, isomers, enantiomers and diastereomers which have qualitative ions or quantitative ions whose retention times overlap each other, it has been difficult to accurately detect SCCPs by the conventional method in which low-resolution mass spectrometry is combined with gas chromatography.

In order to solve the previously described problem which has been present in the prior art, the present invention provides a detection method for congeners of short-chain chlorinated paraffins, the method being capable of exhibiting a satisfactory separation effect and yielding a correct result in both qualitative analysis and quantitative measurement.

### Solution to Problem

The first aspect of the present invention provides a detection method for congeners of short-chain chlorinated paraffins, the method including the following steps:

adding an internal standard substance to a test sample;

subjecting the test sample to a separation process using a comprehensive two-dimensional gas chromatograph formed by connecting a non-polar or weak-polar column and a medium-polar column in series via a modulator; and

detecting the sample by a mass analyzer employing a negative chemical ion source after the separation process.

In the detection method according to the first aspect of the present invention, the stationary phase of the non-polar or weak-polar column may be 95% or 100% methylpolysiloxane. The stationary phase of the non-polar or weak-polar column may have a thickness of 0.1 to 0.25 μm.

In the detection method according to the first aspect of the present invention, the non-polar or weak-polar column may have a length of 15 to 30 m. The non-polar or weak-polar column may have an inner diameter of 0.22 to 0.32 mm.

In the detection method according to the first aspect of the present invention, the stationary phase of the medium-polar column may be 50% phenylpoly-silphenylene-siloxane. The stationary phase of the medium-polar column may have a thickness of 0.1 μm. In the detection method according to the first aspect of the present invention, the medium-polar column may have a length of 2.5 to 3 m. The medium-polar column may have an inner diameter of 0.1 to 0.18 mm.

In the detection method according to the first aspect of the present invention, the procedure for increasing the temperature of the non-polar or weak-polar column may include the successive steps of setting the temperature at an initial temperature of 80° C. to 100° C., maintaining the initial temperature for 1 minutes, increasing the temperature to 160° C. at a rate of 30° C./min, maintaining the temperature at 160° C. for 5 minutes, increasing the temperature to 300° C. at a rate of 1.5° C./min, and maintaining the temperature at 300° C. for 2 minutes.

In the detection method according to the first aspect of the present invention, the procedure for increasing the temperature of the medium-polar column may be the same as the procedure for increasing the temperature of the non-polar or weak-polar column.

In the detection method according to the first aspect of the present invention, the temperature of the negative chemical ion source may be 120° C. to 200° C. In the detection method according to the first aspect of the present invention, the modulation time of the modulator may be 8 to 10 seconds.

In the detection method according to the first aspect of the present invention, the mass analyzer may be a quadrupole mass analyzer.

The second aspect of the present invention provides a creation method for a calibration curve for short-chain chlorinated paraffins, the method including:

Step 1, which includes performing a detection process for n test samples (n≥10) by the detection method according to the first aspect of the present invention as well as determining the peak volume of each congener and the peak volume of the internal standard substance in each of the test samples;

Step 2, which includes calculating a total response factor and the Cl content for each of the test samples by the following equations (S1) through (S3):

Relative Total SCCPs Peak Volume=Σi Relative Peak Volume (Congener i), Equation (S1):

where Relative Peak Volume (Congener i)=Peak Volume (Congener i)/Peak Volume (Internal Standard Substance),

Total Response Factor (SCCPs)=Relative Total SCCPs Peak Volume/SCCPs Concentration, and Equation (S2):

CI Content=Σi[Relative Peak Volume (Congener i)×Chlorine Content (Congener i,calculated from the molecular weight)/Relative Total SCCPs Peak Value]; Equation (S3): and

Step 3, which includes creating the following calibration curve (S4) for short-chain chlorinated paraffins between the total response factor and the Cl content:

Calibration Curve (S4): Total Response Factor=a×(Cl Content)+b.

The third aspect of the present invention provides a quantitative calculation method for an SCCPs content in a sample, the method including:

Step 1, which includes creating the following calibration curve (S4) for short-chain chlorinated paraffins by the creation method according to the second aspect of the present invention;

Step 2, which includes performing a detection process for a test sample by the detection method according to the first aspect of the present invention, and calculating the Cl content in the test sample by the following equations (51) and (S3);

Step 3, which includes calculating a total response factor for the test sample by substituting the Cl content in the test sample into the calibration curve (S4); and

Step 4, which includes calculating the SCCPs concentration in the test sample by the following equation (S2), where:

Relative Total SCCPs Peak Volume=Σi Relative Peak Volume (Congener i), Equation (S1):

where Relative Peak Volume (Congener i)=Peak Volume (Congener i)/Peak Volume (Internal Standard Substance),

Total Response Factor (SCCPs)=Relative Total SCCPs Peak Volume/SCCPs Concentration, Equation (S2):

CI Content=Σi[Relative Peak Volume (Congener i)×Chlorine Content (Congener i,calculated from the molecular weight)/Relative Total SCCPs Peak Value], and Equation (S3):

Calibration Curve (S4): Total Response Factor=a×(Cl Content)+b.

The fourth aspect of the present invention provides a calculation method for a relative concentration SCCPs congeners in a sample, the method including:

Step 1, which includes performing a detection process for a test sample by the detection method according to the first aspect of the present invention and determining a relative feedback by the following equation (S5):

Relative Feedback (Congener i)=Peak Value (Congener i)/Peak Value (Highest Peak among 24 Kinds of Congeners); Equation (S5):

Step 2, which includes determining a relative-check ion signal (congener i) by the following equation (S6):

Relative-Check Ion Signal (Congener i)=Relative Feedback (Congener i)/Abundance (Quantitative Ion of Congener i); Equation (S6):

Step 3, which includes determining a relative concentration coefficient (congener i) by the following equation (S7):

Relative Concentration Coefficient (Congener i)=Relative-Check Ion Signal (Congener i)/Number of Cl Atoms (Congener i); and Equation (S7):

Step 4, which includes determining a relative concentration (congener i) by the following equation (S8):

Relative Concentration (Congener i [%])=Relative Concentration Coefficient (Congener i)/Σi Relative Concentration Coefficient (Congener i). Equation (S8):

### Advantageous Effects of Invention

According to the present invention, the combined use of the low-resolution mass spectrometry and gas chromatography enables accurate qualitative analysis as well as accurate quantitative measurement for SCCPs. The detection is extremely accurate yet can be easily carried out with simple operations.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 shows two-dimensional chromatograms for a C₁₀ family (a), C₁₁ family (b), C₁₂ family (c) and C₁₃ family (d) of the congeners of SCCPs, where the x axis represents the retention time in the first-dimension (1D) chromatograph and while y-axis represents the retention time in the second-dimension (2D) chromatograph.

FIG. 2 shows 48 congeners of a SCCPs mixture (a) and MCCPs mixture (b) on two-dimensional chromatograms, which demonstrate (c) an occurrence of mass interference between the C₁₀H₁₄Cl₈ congeners derived from the SCCPs and the C₁₅H₂₆Cl₆ congeners derived from the MCCPs.

FIG. 3 shows patterns of the distribution of the SCCPs congeners in air samples (gas phase) 3-1 to 3-9 collected in an urban area.

FIG. 4 shows a calibration curve for the relationship between the total response factor and the Cl content in SCCPs.

### DESCRIPTION OF EMBODIMENTS

An embodiment of the present invention provides a detection method for congeners of short-chain chlorinated paraffins including the following steps: adding an internal standard substance to a test sample; subjecting the test sample to a separation process by injecting the test sample into a comprehensive two-dimensional gas chromatograph formed by connecting a non-polar or weak-polar column and a medium-polar column in series via a modulator; and introducing an eluate from the comprehensive two-dimensional gas chromatograph into a mass analyzer employing a negative chemical ion source to detect the sample by the mass analyzer after the separation process.

An analysis on a test sample is performed by adding an internal standard substance to the test sample and subsequently injecting the test sample into a comprehensive two-dimensional gas chromatograph formed by connecting a non-polar or weak-polar column and a medium-polar column in series via a modulator.

Preparation of Test Samples There is no specific limitation on the method for preparing test samples as long as the method satisfies basic requirements for the analysis by the instrument concerned.

For example, a sample of commercially available industrial product of CPs can be injected into the instrument for the measurement by being diluted with a solvent. For a sample collected from the air, a pretreatment for obtaining the test sample is required. For example, for the collection of the gas-phase SCCPs, polyurethane foam is used. After the completion of the collection, the internal standard substance is added to the collected gas-phase SCCPs. The obtained mixture is subjected to accelerated solvent extraction, and subsequently, to liquid-liquid extraction. After that, a clean-up process is performed to remove interfering substances, such as the organochlorine agricultural chemicals or polychlorinated biphenyl. Ultimately, SCCPs are eluted and collected to obtain the test sample.

For the collection of the particle-phase SCCPs, a quartz fiber filter can be used. After the completion of the collection, the internal standard substance is added to the collected particle-phase SCCPs. The obtained mixture is subjected to accelerated solvent extraction, and subsequently, to liquid-liquid extraction. After that, a clean-up process is performed to remove interfering substances, such as the organochlorine agricultural chemicals or polychlorinated biphenyl. Ultimately, SCCPs are eluted and collected to obtain the test sample. There is no specific limitation on the kind of internal standard substance to be added to the test sample. A preferable example is 1,5,5,6,6,10-hexachloridecane.

Injection Method

There is no specific limitation on the injection method. For example, an autosampler in a split-less mode may be used for the injection, with an injection volume of 1 μL and at an injection temperature of 280° C. It is more preferable to use helium gas as the carrier gas and inject it at a constant linear velocity. The total flow rate is 50 mL/min. The flow rate within the column is 1.2 mL/min. The pressure within the column is 269.8 kPa.

Non-Polar or Weak-Polar Column (or Faint-Polar Column)

The separation process for the test sample is performed using the non-polar or weak-polar column as the first-dimension column. In the present method, since the SCCPs in the test sample are low in polarity, the congeners in the SCCPs can be separated by the boiling point (i.e. the length of the carbon chain) by using the non-polar or weak-polar column as the first-dimension column.

As the stationary phase of the non-polar or weak-polar column, 95% or 100% methylpolysiloxane may be used. An example of the stationary phase is (5% phenyl)-95% methylpolysiloxane.

The stationary phase of the non-polar or weak-polar column has a thickness of 0.1 to 0.25 μm, preferably 0.1 μm. The use of the first-dimension column with a stationary phase of 0.1 μm in thickness is preferable in that it effectively shortens the analysis time.

The non-polar or weak-polar column has a column length of 15 to 30 m, and preferably 15 m. The use of the first-dimension column having a column length of 15 m is preferable in that it effectively shortens the analysis time.

The non-polar or weak-polar column has a diameter of 0.22 to 0.32 mm, and more preferably, 0.25 mm.

Procedure for Increasing Temperature of Non-Polar or Weak-Polar Column

There is no specific limitation on the procedure for increasing the temperature of the non-polar or weak-polar column as long as the column peaks can be certainly separated. A preferable procedure includes the successive steps of setting the temperature of the column oven for the first-dimension column at an initial temperature of 80° C. to 100° C., maintaining the initial temperature for 1 minutes, increasing the temperature to 160° C. at a rate of 30° C./min, maintaining the temperature at 160° C. for 5 minutes, increasing the temperature to 300° C. at a rate of 1.5° C./min, and maintaining the temperature at 300° C. for 2 minutes.

Modulator

There is no specific limitation on the condition for the modulator as long as the entire amount of eluate from the first-dimension column assuredly flows into the second-dimension column within one modulation time.

A preferable length of one modulation time is 8 to 10 seconds. A modulation time shorter than 8 seconds does not ensure that the entire amount of eluate flows into the second-dimension column within one modulation time; for example, a compound having a high boiling point or high polarity may partially enter the second-dimension column within the next modulation time. Setting the modulation time within the range of 8 to 10 seconds satisfactorily allows the eluate to entirely flow into the second-dimension column. Accordingly, a modulation time that exceeds 10 seconds is unnecessarily long and unfavorably affects the efficiency of the analysis.

A preferable range of the modulation temperature is 250° C. to 400° C. In consideration of the temperature resistance of the column as well as the necessity to completely release captured compounds from the modulation loop into the second-dimension column, the modulation temperature should preferably be within a range of 300° C. to 350° C., e.g. 350° C.

A preferable hot-purge period is 300 ms. A preferable flow rate of the cold-purge gas is 5 L/min

Medium-Polar Column

The medium-polar column serving as the second-dimension column further separates the test sample. A commercially available product can be used as the medium-polar column. It should have a higher degree of polarity than weak-polarity columns as well as a lower degree of polarity than strong-polarity columns (or high-polarity columns, such as a column using polyethylene glycol as its stationary phase).

A preferable stationary phase of the medium-polar column is 50% phenylpoly(silphenylenesiloxane).

A preferable thickness of the stationary phase of the medium-polar column is 0.1 μm. The use of this thickness produces the effects of high-speed separation and concentration.

The medium-polar column has a column length of 2.5 to 3 m. This second-dimension column includes a 1-m section as the modulator circuit, a 0.5-m section for the connection with the first-dimension column, and a section of 1 to 1.5 m for producing the separating effect. As the second-dimension column, a two-dimensional column which is extremely short, e.g. 2.5 m in length, is used since it is necessary to complete the separation within the modulation time.

The medium-polar column has a diameter of 0.1 to 0.18 mm A preferable choice is 0.1 mm from the point of view of obtaining a higher level of separation effect.

Procedure for Increasing Temperature of Medium-Polar Column

There is no specific limitation on the procedure for increasing the second-dimension column, although it is preferable to use the same procedure as used for the first-dimension column That is to say, it should preferably include the successive steps of setting the temperature of the column oven at an initial temperature of 80° C. to 100° C., maintaining the initial temperature for 1 minutes, increasing the temperature to 160° C. at a rate of 30° C./min, maintaining the temperature at 160° C. for 5 minutes, increasing the temperature to 300° C. at a rate of 1.5° C./min, and maintaining the temperature at 300° C. for 2 minutes. Such a temperature-increasing procedure helps to separate column peaks.

The eluate from the comprehensive two-dimensional gas chromatograph is introduced into a low-resolution mass analyzer which employs a negative chemical ion source and the technique of selective ion monitoring. The “low resolution” means that the resolution of the masses detected with the mass analyzer is at a level of first or second decimal place. The low-resolution mass analyzer may be a quadrupole mass analyzer. For example, it may be a triple quadrupole mass analyzer.

Negative Chemical Ion Source

Negative chemical ion sources have weak ionization power for SCCPs and produce only a small amount of fragment ions. Accordingly, negative chemical ion sources have a satisfactory level of selectivity and sensitivity.

A preferable reaction gas for the negative chemical ion source is CH₄. The temperature of the negative chemical ion source is within a range of 120° C. to 200° C. In order to achieve both a reduction in the rate of contamination of the ion source and an improvement in ionization efficiency, it is preferable to set the temperature of the negative chemical ion source at 200° C.

Triple Quadrupole

The direct and RF voltages in the triple quadrupole are automatically regulated according to the selection of the quantitative ion and the qualitative ion.

Quantitative Ion and Qualitative Ion

A detection process for SCCPs standard substances was performed using the detection method for congeners of short-chain chlorinated paraffins according to the embodiment of the present invention. It should be noted that the low-resolution mass analyzer was operated in a full-scan mode for the detection. Among the detected ions of the various kinds of congeners, the ion with the highest abundance was selected as the quantitative ion, while the ion with the second highest abundance was selected as the qualitative ion. The result is shown in Table 1.

TABLE 1

| Family of Congeners | Quantative Ion m/z | Qualitative Ion m/z |
|---|---|---|
| C₁₀H₁₇Cl₅ | 279 | 277 |
| C₁₀H₁₆Cl₆ | 313 | 315 |
| C₁₀H₁₅Cl₇ | 347 | 349 |
| C₁₀H₁₄Cl₈ | 381 | 383 |
| C₁₀H₁₃Cl₉ | 415 | 417 |
| C₁₀H₁₂Cl₁₀ | 449 | 451 |
| C₁₁H₁₉Cl₅ | 293 | 291 |
| C₁₁H₁₈Cl₆ | 327 | 329 |
| C₁₁H₁₇Cl₇ | 361 | 363 |
| C₁₀H₁₆Cl₈ | 395 | 397 |
| C₁₁H₁₅Cl₉ | 429 | 431 |
| C₁₁H₁₄Cl₁₀ | 463 | 465 |
| C₁₂H₂₁Cl₅ | 307 | 305 |
| C₁₂H₂₀Cl₆ | 341 | 343 |
| C₁₂H₁₉Cl₇ | 375 | 377 |
| C₁₂H₁₈Cl₈ | 409 | 411 |
| C₁₂H₁₇Cl₉ | 445 | 443 |
| C₁₂H₁₆Cl₁₀ | 479 | 477 |
| C₁₃H₂₃Cl₅ | 319 | 321 |
| C₁₃H₂₂Cl₆ | 355 | 357 |
| C₁₃H₂₁Cl₇ | 389 | 391 |
| C₁₃H₂₀Cl₈ | 423 | 425 |
| C₁₃H₁₉Cl₉ | 459 | 457 |
| C₁₃H₁₈Cl₁₀ | 493 | 491 |
| Internal Standard | 323 | 321 |
| Substance | | |
| ¹³C-1,5,5,6,6,10- | | |
| hexachloro-n-decane | | |

Creation of Calibration Curve

The calibration curve was created as follows:

(1) The detection process by the detection method according to the embodiment of the present invention was performed for the samples Nos. 1-13 in Table 2 shown below. As a result of the detection, the peak volume of each congener and that of the internal standard substance in each sample were obtained. The samples Nos. 1-13 each had a SCCPs content of 750 ppm.

TABLE 2

| No. | 1 | 2 | 3 | 4 | 5 | 6 | 7 | 8 | 9 | 10 | 11 | 12 | 13 |
|---|---|---|---|---|---|---|---|---|---|---|---|---|---|
| Cl Content | 51.5 | 52.5 | 53.5 | 54.5 | 55.5 | 56.3 | 56.7 | 57.8 | 56.0 | 59.3 | 60.5 | 61.5 | 53.0 |
| (calculated from | | | | | | | | | | | | | |
| label of standard | | | | | | | | | | | | | |
| substances, %) | | | | | | | | | | | | | |
| SCCP Standard | 1 | 3 | 1 | 1 | 0 | 0 | 1 | 0 | 0 | 0 | 0 | 0 | 0 |
| Substance | | | | | | | | | | | | | |
| (Cl content, 51.5%) | | | | | | | | | | | | | |
| SCCP Standard | 0 | 1 | 1 | 3 | 1 | 9 | 1 | 7 | 2 | 1 | 1 | 1 | 0 |
| Substance | | | | | | | | | | | | | |
| (Cl content, 55.5%) | | | | | | | | | | | | | |
| SCCP Standard | 0 | 0 | 0 | 0 | 0 | 1 | 1 | 3 | 1 | 1 | 2 | 4 | 1 |
| Substance | | | | | | | | | | | | | |
| (Cl content, 63%) | | | | | | | | | | | | | |

(2) The total response factor (Nos. 1-13) and the Cl content (Nos. 1-13) of each sample was calculated by equations (S1) through (S3):

Relative Total SCCPs Peak Volume=Σi Relative Peak Volume (Congener i), Equation (S1):

where Relative Peak Volume (Congener i)=Peak Volume (Congener i)/Peak Volume (Internal Standard Substance);

Total Response Factor (SCCPs)=Relative Total SCCPs Peak Volume/SCCPs Concentration; and Equation (S2):

CI Content (calculated by chromatogram)=Σi [Relative Peak Volume (Congener i)×Chlorine Content (Congener i,calculated from the molecular weight)/Relative Total SCCPs Peak Value]. Equation (S3):

The Cl contents of the samples Nos. 1-13 obtained by the calculation are shown in Table 3.

TABLE 3

| No. | 1 | 2 | 3 | 4 | 5 | 6 | 7 | 8 | 9 | 10 | 11 | 12 | 13 |
|---|---|---|---|---|---|---|---|---|---|---|---|---|---|
| Cl Content | 0.585 | 0.595 | 0.602 | 0.604 | 0.608 | 0.618 | 0.636 | 0.635 | 0.634 | 0.641 | 0.645 | 0.648 | 0.651 |
| (calculated from | | | | | | | | | | | | | |
| chromatogram) | | | | | | | | | | | | | |

(3) The following calibration curve (S4) showing a relationship between the total response factor and the Cl content was calculated:

Calibration Curve (S4): Total Response Factor=a×(Cl Content)+b.

The created calibration curve (S4) is shown in FIG. 4.

Quantitative Calculation Method for SCCPs Content in Real Samples

(1) The detection using the detection method according to the embodiment of the present invention was performed for real samples, and the Cl content (real sample) was calculated by equations (S1) and (S3).

(2) The Cl content (real sample) was substituted into the calibration curve (S4) to calculate the total response factor (real sample).

(3) The total SCCPs concentration (real sample) in the real sample was calculated by equation (S2).

Quantitative Calculation Method for Relative Concentration of Congener

(1) The detection using the detection method according to the embodiment of the present invention was performed for real samples, and the relative feedback was calculated by the following equation (S5).

Relative Feedback (Congener i)=Peak Value (Congener i)/Peak Value (Highest Peak among 24 Kinds of Congeners). Equation (S5):

(2) A relative-check ion signal (congener i) was calculated by the following equation (S6). The abundance of the quantitative ion of the congener is shown in Table 4.

Relative-Check Ion Signal (Congener i)=Relative Feedback (Congener i)/Abundance (Quantitative Ion of Congener i) Equation (S6):

TABLE 4

| Family of Congeners | Quantitative Ion m/z | Abundance (%) |
|---|---|---|
| C₁₀H₁₇Cl₅ | 279 | 36.9 |
| C₁₀H₁₆Cl₆ | 313 | 38.2 |
| C₁₀H₁₅Cl₇ | 347 | 34.0 |
| C₁₀H₁₄Cl₈ | 381 | 27.9 |
| C₁₀H₁₃Cl₉ | 415 | 27.4 |
| C₁₀H₁₂Cl₁₀ | 449 | 21.5 |
| C₁₁H₁₉Cl₅ | 293 | 39.4 |
| C₁₁H₁₈Cl₆ | 327 | 38.7 |
| C₁₁H₁₇Cl₇ | 361 | 35.7 |
| C₁₁H₁₆Cl₈ | 395 | 30.8 |
| C₁₁H₁₅Cl₉ | 429 | 27.8 |
| C₁₁H₁₄Cl₁₀ | 463 | 29.1 |
| C₁₂H₂₁Cl₅ | 307 | 28.6 |
| C₁₂H₂₀Cl₆ | 341 | 36.8 |
| C₁₂H₁₉Cl₇ | 375 | 34.7 |
| C₁₂H₁₈Cl₈ | 409 | 30.4 |
| C₁₂H₁₇Cl₉ | 445 | 29.5 |
| C₁₂H₁₆Cl₁₀ | 479 | 28.8 |
| C₁₃H₂₃Cl₅ | 319 | 26.4 |
| C₁₃H₂₂Cl₆ | 355 | 29.8 |
| C₁₃H₂₁Cl₇ | 389 | 30.8 |
| C₁₃H₂₀Cl₈ | 423 | 28.9 |
| C₁₃H₁₉Cl₉ | 459 | 30.4 |
| C₁₃H₁₈Cl₁₀ | 493 | 25.3 |

(3) The relative concentration coefficient (congener i) was calculated by the following equation (S7).

Relative Concentration Coefficient (Congener i)=Relative-Check Ion Signal (Congener i)/Number of Cl Atoms (Congener i) Equation (S7):

(4) The relative concentration (congener i) was calculated by the following equation (S8).

Relative Concentration (Congener i [%])=Relative Concentration Coefficient (Congener i)/Σi Relative Concentration Coefficient (Congener i) Equation (S8):

### First Example

Test Samples

Commercially available C₁₀ mixture, C₁₁ mixture, C₁₂ mixture and C₁₃ mixture (manufactured by Dr. Ehrenstorfer GmbH, Germany) were used as test samples 1-1. ¹³C-1,5,5,6,6,10-hexachloro-n-decane was used as the internal standard substance.

C₁₀ mixture: Cyclohexane was used as the solvent. The solubility was 10 ng/μL. The chlorine content was 65.02 wt %.

C₁₁ mixture: This sample was prepared by mixing two kinds of C₁₁ mixtures, which respectively had chlorine contents of 45.5 wt % and 65.25 wt %, at a volume ratio of 1:1. Cyclohexane was used as the solvent. The solubility was 10 ng/μL.

C₁₂ mixture: This sample was prepared by mixing two kinds of C₁₂ mixtures, which respectively had chlorine contents of 55 wt % and 69.98 wt %, at a volume ratio of 1:1. Cyclohexane was used as the solvent. The solubility was 10 ng/μL.

C₁₃ mixture: This sample was prepared by mixing two kinds of C₁₃ mixtures, which respectively had chlorine contents of 55.03 wt % and 65.18 wt %, at a volume ratio of 1:1. Cyclohexane was used as the solvent. The solubility was 10 ng/μL.

Instrumental Configuration

Comprehensive two-dimensional gas chromatograph: GC×GC capillary columns connected via a thermal modulator (manufactured by Zoex, USA) were used for the comprehensive two-dimensional gas chromatograph. The first-dimension column was a non-polar column having a stationary phase composed of 5% phenyl and 95% methylpolysiloxane. The film thickness of the stationary phase was 0.1 μm. The column was 0.25 mm in diameter and 15 m in length (InertCap 5MS/Sil capillary column, manufactured by GL Sciences Inc., Japan).

The second-dimension column was a medium-polar column. The stationary phase was 50% phenylpoly(silphenylenesiloxane). The film thickness of the stationary phase was 0.1 μm. The column was 0.1 mm in diameter and 2.5 m in length (manufactured by SGE analytical science, Australia).

The procedure for increasing the temperature of the first-dimension column included the successive steps of setting the temperature at an initial temperature of 80° C. to 100° C., maintaining the initial temperature for 1 minutes, increasing the temperature to 160° C. at a rate of 30° C./min, maintaining the temperature at 160° C. for 5 minutes, increasing the temperature to 300° C. at a rate of 1.5° C./min, and maintaining the temperature at 300° C. for 2 minutes.

The procedure for increasing the temperature of the second-dimension column was the same as the procedure used for increasing the temperature of the first-dimension column.

Helium gas was used as the carrier gas and injected at a constant linear velocity.

The modulation time of the modulator was 10 seconds. The hot-purge time at 350° C. was 300 ms. The flow rate for the cold purge was 5 L/min.

Low-resolution mass analyzer: A triple-quadrupole low-resolution mass analyzer was used. A negative chemical ion source (NCI) was adopted. The temperature of the ion source was set at 200° C. The analysis was performed in a selective ion monitoring mode, using methane as the reaction gas.

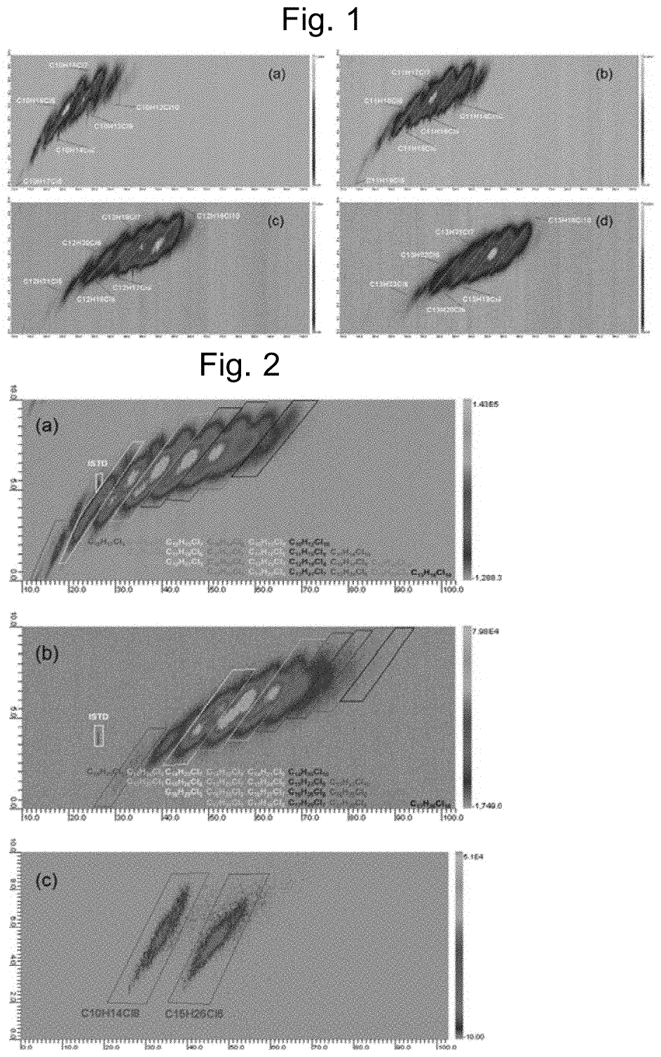

The result is shown in FIG. 1. A satisfactory level of separation effect was obtained for the 24 kinds of congeners in the SCCPs.

### Comparative Example

In the comparative example, the test samples and instrumental configuration were the same as in the first example except for the differences which will be hereinafter described.

The first-dimension column was a medium-polar column having a stationary phase composed of 50% phenyl and 50% methylpolysiloxane. The film thickness of the stationary phase was 0.25 μm. The column was 0.25 mm in diameter and 15 m in length (InertCap 17MS capillary column, manufactured by GL Sciences Inc., Japan).

The second-dimension column was a non-polar column. The stationary phase was 100% dimethylpolysiloxane. The film thickness of the stationary phase was 0.1 μm. The column was 0.1 mm in diameter and 2.5 m in length (BPX-1, manufactured by SGE analytical science, Australia). The separation effect for the 24 kinds of congeners in the SCCPs in the comparative example was low, so that some of the congeners were missed.

### Second Example

Test Samples

Three kinds of commercially available C₁₀-C₁₃ mixtures (Nos. 1-3) were mixed at a volume ratio of 1:1:1 to obtain a test sample 2-1. ¹³C-1,5,5,6,6,10-hexachloro-n-decane was used as the internal standard substance.

C₁₀-C₁₃ mixture (No. 1): Cyclohexane was used as the solvent. The solubility was 100 ng/μL. The chlorine content was 51.5 wt %.

C₁₀-C₁₃ mixture (No. 2): Cyclohexane was used as the solvent. The solubility was 100 ng/μL. The chlorine content was 55.5 wt %.

Cm-CD mixture (No. 3): Cyclohexane was used as the solvent. The solubility was 100 ng/μL. The chlorine content was 63 wt %.

Three kinds of commercially available C₁₄-C₁₇ mixtures (Nos. 4-6) were mixed at a volume ratio of 1:1:1 to obtain a test sample 2-2. ¹³C-1,5,5,6,6,10-hexachloro-n-decane was used as the internal standard substance.

C₁₄-C₁₇ mixture (No. 4): Cyclohexane was used as the solvent. The solubility was 100 ng/μL. The chlorine content was 42 wt %.

C₁₄-C₁₇ mixture (No. 5): Cyclohexane was used as the solvent. The solubility was 100 ng/μL. The chlorine content was 52 wt %.

C₁₄-C₁₇ mixture (No. 6): Cyclohexane was used as the solvent. The solubility was 100 ng/μL. The chlorine content was had a chlorine content of 57 wt %.

The instrumental configuration was the same as in the first example. The result is shown in FIG. 2.

If one-dimensional gas chromatography low-resolution mass spectrometry is solely used, mass interference occurs between the [M−Cl]⁻ ion group of the SCCPs congeners and that of the MCCPs congeners which have five more carbon atoms and two less chlorine atoms than the SCCPs congeners. For example, if both C₁₀H₁₄Cl₈ and C₁₅H₂₆Cl₆ are present, mass interference occurs, which makes it impossible to distinguish between the two compounds. Such an interference can be resolved by the detection method according to the present embodiment, as shown in FIG. 2. SCCPs mixtures can be completely separated from MCCPs mixtures.

### Third Example

Preparation of Test Samples

Air samples were collected with a high-volume air sampler (HV-1000 F, manufactured by SIBATA SCIENTIFIC TECHNOLOGY LTD.) placed on a roof of a building (at a height of approximately 30 meters from the ground). The high-volume air sampler was operated at a flow rate of 700 L/min. The sampling period was 24 hours. The sampling was continued for nine days to obtain nine corresponding samples, which were labeled as 3-1 to 3-9.

For the gas-phase SCCPs, polyurethane foam was used for the collection. After the completion of the collection, the internal standard substance (¹³C-1,5,5,6,6,10-hexachloro-n-decane) was added to the collected gas-phase SCCPs. The polyurethane foam was subsequently subjected to accelerated solvent extraction using n-hexane/dichloromethane mixed at 1:1. Next, liquid-liquid extraction was performed, in which organic substances were almost entirely removed by sulfuric acid. Then, a clean-up process for removing interfering substances, such as the organochlorine agricultural chemicals or polychlorinated biphenyl, was performed using a multilayer silica gel column Ultimately, the multilayer silica gel column was rinsed with 80 mL of n-hexane, and SCCPs were eluted with n-hexane/dichloromethane mixed at a ratio of 8:2. The collected eluate was condensed to 200 μm to obtain a test sample.

For the particle-phase SCCPs, a quartz fiber filter was used for the collection. After the completion of the collection, the internal standard substance (¹³C-1,5,5,6,6,10-hexachloro-n-decane) was added to the collected particle-phase SCCPs. The quartz fiber filter was subsequently subjected to accelerated solvent extraction using n-hexane/dichloromethane mixed at 1:1. Next, liquid-liquid extraction was performed, in which organic substances were almost entirely removed by sulfuric acid. Then, a clean-up process for removing interfering substances, such as the organochlorine agricultural chemicals or polychlorinated biphenyl, was performed using a multilayer silica gel column Ultimately, the multilayer silica gel column was rinsed with 80 mL of n-hexane, and SCCPs were eluted with n-hexane/dichloromethane mixed at a ratio of 8:2. The collected eluate was condensed to 200 μm to obtain a test sample.

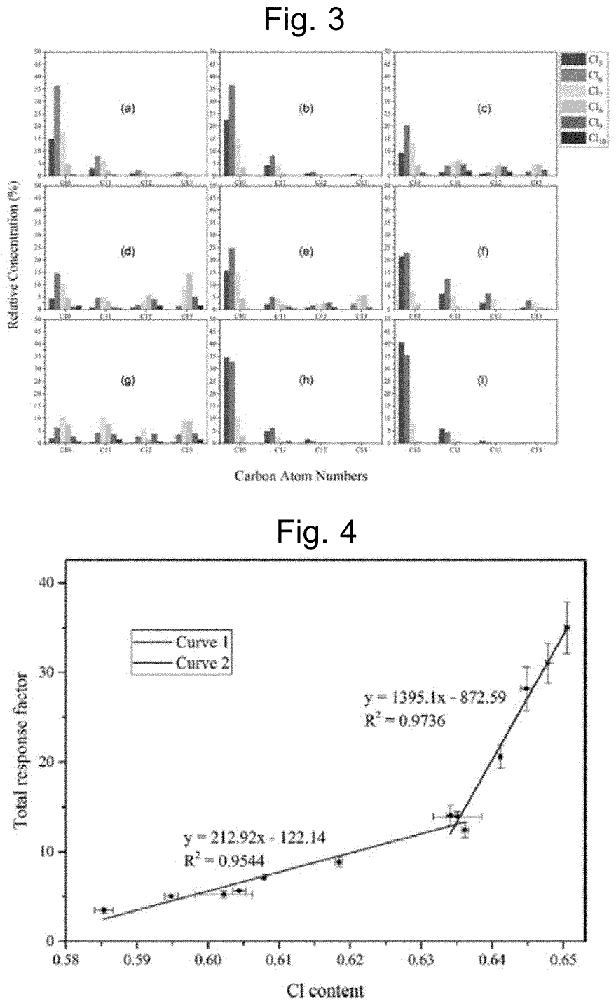

An analysis was performed using the same instrumental configuration as in the first example, and a calculation was performed by a calculation method which is commonly known in the technical area to which the present invention pertains (e.g. a calculation method described in Non Patent Literature 1). The result is shown in FIG. 3.

As demonstrated in FIG. 3, the detection method according to the embodiment of the present invention enables the detection of the 24 kinds of congeners of the SCCPs in the air with a high level of detection accuracy that allows for quantitative measurements.

1. A detection method for congeners of short-chain chlorinated paraffins, the method comprising following steps:
adding an internal standard substance to a test sample;
subjecting the test sample to a separation process using a comprehensive two-dimensional gas chromatograph formed by connecting a non-polar or weak-polar column and a medium-polar column in series via a modulator; and
detecting the sample by a mass analyzer employing a negative chemical ion source after the separation process.

2. The detection method according to claim 1, wherein a stationary phase of the non-polar or weak-polar column is 95% or 100% methylpolysiloxane, and has a thickness of 0.1 to 0.25 μm.

3. The detection method according to claim 1, wherein the non-polar or weak-polar column has a length of 15 to 30 m and an inner diameter of 0.22 to 0.32 mm.

4. The detection method according to claim 1, wherein a stationary phase of the medium-polar column is 50% phenylpoly(silphenylene-siloxane), and has a thickness of 0.1 μm.

5. The detection method according to claim 1, wherein the medium-polar column has a length of 2.5 to 3 m and an inner diameter of 0.1 to 0.18 mm.

6. The detection method according to claim 1, wherein a procedure for increasing a temperature of the non-polar or weak-polar column includes successive steps of setting the temperature at an initial temperature of 80° C. to 100° C., maintaining the initial temperature for 1 minutes, increasing the temperature to 160° C. at a rate of 30° C./min, maintaining the temperature at 160° C. for 5 minutes, increasing the temperature to 300° C. at a rate of 1.5° C./min, and maintaining the temperature at 300° C. for 2 minutes.

7. The detection method according to claim 1, wherein a procedure for increasing a temperature of the medium-polar column is same as a procedure for increasing a temperature of the non-polar or weak-polar column.

8. The detection method according to claim 1, wherein a temperature of the negative chemical ion source is 120° C. to 200° C.

9. The detection method according to claim 1, wherein a modulation time of the modulator is 8 to 10 seconds.

10. The detection method according to claim 1, wherein the mass analyzer is a quadrupole mass analyzer.

11. A creation method for a calibration curve for short-chain chlorinated paraffins, the method comprising:
Step 1, which includes performing a detection process for n test samples (n≥10) by the detection method according to claim 1 as well as determining a peak volume of each congener and a peak volume of the internal standard substance in each of the test samples;
Step 2, which includes calculating a total response factor and a Cl content for each of the test samples by following equations (S1) through (S3):
Relative Total SCCPs Peak Volume=Σi Relative Peak Volume (Congener i), Equation (S1):
where Relative Peak Volume (Congener i)=Peak Volume (Congener i)/Peak Volume (Internal Standard Substance),
Total Response Factor (SCCPs)=Relative Total SCCPs Peak Volume/SCCPs Concentration, and Equation (S2):
CI Content=Σi [Relative Peak Volume (Congener i)×Chlorine Content (Congener i,calculated from the molecular weight)/Relative Total SCCPs Peak Value]; and Equation (S3):
Step 3, which includes creating a following calibration curve (S4) for short-chain chlorinated paraffins between the total response factor and the Cl content:
Calibration Curve (S4): Total Response Factor=a×(Cl Content)+b.

12. A quantitative calculation method for an SCCPs content in a sample, the method comprising:
Step 1, which includes creating a following calibration curve (S4) for short-chain chlorinated paraffins by the creation method according to claim 11:
Calibration Curve (S4): Total Response Factor=a×(Cl Content)+b;
Step 2, which includes performing a detection process for a test sample by the detection method according to claim 1, and calculating a Cl content in the test sample by following equations (S1) and (S3):
Relative Total SCCPs Peak Volume=Σi Relative Peak Volume (Congener i), Equation (S1):
where Relative Peak Volume (Congener i)=Peak Volume (Congener i)/Peak Volume (Internal Standard Substance),
CI Content=Σi [Relative Peak Volume (Congener i)×Chlorine Content (Congener i,calculated from the molecular weight)/Relative Total SCCPs Peak Value]; Equation (S3):
Step 3, which includes calculating a total response factor for the test sample by substituting the Cl content in the test sample into the calibration curve (S4); and
Step 4, which includes calculating an SCCPs concentration in the test sample by a following equation (S2):
Total Response Factor (SCCPs)=Relative Total SCCPs Peak Volume/SCCPs Concentration. Equation (S2):

13. A calculation method for a relative concentration SCCPs congeners in a sample, the method comprising:
Step 1, which includes performing a detection process for a sample by the detection method according to claim 1 and determining a relative feedback by a following equation (S5):
Relative Feedback (Congener i)=Peak Value (Congener i)/Peak Value (Highest Peak among 24 Kinds of Congeners); Equation (S5):
Step 2, which includes determining a relative-check ion signal (congener i) by a following equation (S6):
Relative-Check Ion Signal (Congener i)=Relative Feedback (Congener i)/Abundance (Quantitative Ion of Congener i); Equation (S6):
Step 3, which includes determining a relative concentration coefficient (congener i) by a following equation (S7):
Relative Concentration Coefficient (Congener i)=Relative-Check Ion Signal (Congener i)/Number of Cl Atoms (Congener i); and Equation (S7):
Step 4, which includes determining a relative concentration (congener i) by a following equation (S8):
Relative Concentration (Congener i=Relative Concentration Coefficient (Congener i)/Σi Relative Concentration Coefficient (Congener i). Equation (S8):
